(19) United States
(12) Patent Application Publication
(10) Pub. No.: US 2003/0124285 A1
(43) Pub. Date: Jul. 3, 2003

(54) Removable core for pre-stretched tube

(76) Inventors: Ernest A. Hopcus, Austin, TX (US); Winfried Knorr, Nuess (DE)

Correspondence Address: Office of Intellectual Property Counsel, 3M Innovative Properties Company, PO Box 33427, St. Paul, MN, 55133-3427, US

(21) Appl. No.: 10/036,993

(22) Filed: Dec. 31, 2001

(51) Int. Cl. B32B 1/08

(52) U.S. Cl. 428/36.9; 428/43

(57) ABSTRACT

A removable core for supporting a pre-stretched elastomeric tube in a radially expanded condition formed from a unitary tube having first and second opposite ends and at least one primary line of localized weakening starting at the first end and terminating at the second end of the tube, and a plurality of substantially parallel secondary lines of localized weakening. Each secondary weakening line extends substantially circumferentially of the tube from the at least one primary weakening line at the one side thereof to a termination point at the other side of the at least one primary weakening line and spaced apart therefrom. Adjacent secondary weakening lines alternately extend from different sides of the at least one primary weakening line to termination points at the respective other side of the at least one primary weakening line to define at least one strip. This strip begins at the first end of the tube and substantially continues circumferentially in a serpentine manner to the second end of the tube, wherein the at least one strip comprises a free end starting from the second end of the tube and extending through the tube so as to project from the first end of the tube.

### TECHNICAL FIELD OF THE INVENTION

The present invention relates to a core for supporting an elastomeric tube in a radially expanded or pre-stretched condition wherein the core can be removed to allow the pre-stretched elastomeric tube (PST) to contract into contact with an object to be enclosed within the tube. Moreover, the present invention relates to a covering assembly comprising a PST and a core for supporting the PST in a radially expanded condition.

### BACKGROUND OF THE INVENTION

One method of insulating and environmentally protecting a connector for a power cable or other cable is by use of a contractible insulating tube expanded to fit over the outer surface of a hollow cylindrical core. The tube and the core are slid over one cable end and the cables are connected by means of the connector. Thereafter the tube and the core are repositioned over the connector area and the hollow cylindrical core is removed so that the expanded insulating tube may contract into contact with the connector and the cables.

U.S. Pat. Nos. 3,515,798 and 4,503,105 both describe a one-piece rigid plastic core having interconnected adjacent coils of a core ribbon in a closed helical configuration. One end of the core ribbon is partially unwound and fed back through the core. Pulling on this end will cause the core ribbon to unwind and, accordingly, allow the pre-stretched tube to contract. Because the core ribbon is helically wound, the core ribbon as it is extracted through the space between the core and the object over which the core has been positioned must be rotated around the object as the core ribbon end is pulled. This is cumbersome and does not permit the use of automation to remove the core as the machine cannot release the core on one lateral side of the object and regrasp it on the other lateral side of the object.

PCT Patent Application WO-A-93/22816 and U.S. Pat. No. 5,589,667 both describe a straight pull-out core ribbon which overcomes the aforesaid drawback. The hollow structure of this type of core is formed by bending a flat sheet of plastic material into a tube-like shape. The flat sheet is held in the tube-like condition by means of interlocking means formed at the longitudinal edges of the sheet. The interlocking means elements at the one longitudinal edge interlock with their respective interlocking means counterparts at the other longitudinal edge. The flat sheet is provided with a plurality of parallel weakening lines alternatively starting at the one longitudinal edge of the sheet and terminating at a termination point spaced apart from the respective opposite longitudinal edge. By this configuration, a strip or ribbon is defined which begins at the free end and continues in a serpentine manner between and at the termination points around consecutive lines. Accordingly, the ribbon can be removed by pulling at its free end wherein the direction in which the ribbon or strip upon removal extends around the object over which the core and the PST is repositioned is inverted after each winding. This results in a straight pull-out without twisting successively which simplifies the removal handling. However, the flat sheet of material must be provided with a specific design at its longitudinal edges in order to provide for the interlocking means. This complicates manufacturing of the sheet material. Moreover, forces acting at the interlocking means tend to cause the bent sheet material to go back into its original flat condition; thus, it is somewhat difficult and cumbersome to maintain the tube-like shape of the core while loading the PST. Finally, at the interlocking means the core and the PST deviate from the circumferential design visually which may affect consumer acceptance of the covering assembly formed of the core and PST.

PCT Patent Application WO-A-96/21963 relates to a pre-stretched modular barrier boot having a resiliently deformable T-shaped end closure cap provided with two radially expanded pro-stretched tube portions maintained in the shape by means of a support core as set forth and described in PCT Patent Application WO-A-93/22816 or U.S. Pat. No. 5,589,667 (see FIG. 2 and lines 21 to 27 of page 7 of WO-A-96/21963).

European Patent Application EP-A 0 637 117 illustrates another support core for a PST in which a flexible flat sheet having several serpentine like strips is bent to provide a tubular supporting core wherein the lateral edges of the flexible sheet are held together by means of interlocking devices. The problems and disadvantages of this core design are identical to those described hereinabove.

Accordingly, there is a need for a removable core for supporting a pre-stretched elastomeric tube in a radially expanded condition wherein the manufacturing process of the removable core is relatively easy and wherein the removal of the core is achieved by pulling a strip or ribbon thereof straight out without twisting around the object to be enclosed within the PST. There is also a need for a covering assembly for enclosing an object comprising a cold shrinkable elastomeric covering tube and a removable core for supporting the covering tube in a pre-stretched radially expanded condition.

### SUMMARY OF THE INVENTION

According to the present invention there is provided a removable core built from a unitary tube made of, by way of example only, a plastic material wherein the unitary tube is provided with primary and secondary weakening lines formed into the unitary tube. The unitary tube with its weakening lines forms the removable core which consists of at least one strip or ribbon extending circumferentially about the tube in a serpentine manner.

The unitary tube of the removable core according to the invention is provided with a primary line of localized weakening extending from a first end of the tube to a second end thereof opposite to the first end. Transversely to the primary weakening line there are several secondary lines of localized weakening which preferably extend substantially circumferentially about the tube. Each of these secondary weakening lines starts from the primary weakening line and extends to the one side of the primary weakening line up to a termination point at the other side of the primary weakening line and spaced apart therefrom. That means that each secondary weakening line extends about less than 360° and nearly about one winding. The secondary weakening lines are substantially parallel to each other. Accordingly, this secondary weakening line design provides for a strip or ribbon extending substantially circumferentially about the tube in a serpentine manner from the first end of the tube to its opposite second end. The strip is fed back from one of the ends of the tube through the tube so as to project from the other end of the tube.

One of the main aspects of the present invention is that the integrity of the unitary tube forming the removable core is maintained from the beginning of the manufacturing process of the removable core until its removal from the PST supported by the core. No interlocking means are necessary for maintaining the tubular shape of the removable core. The strip or ribbon of the removable core according to the invention can be pulled straight out without twisting around the object to be covered by the PST over more than one winding since those portions of the serpentine-like strip between a termination point and the primary weakening line defining a point of unwinding direction inversion point at which the direction in which the strip is unwound when pulling it is inverted by 180°.

Basically, the primary line of localized weakening can be a straight line being parallel to or inclined with respect to the longitudinal axis of the unitary tube. However, due to stability reasons it is preferred that the primary weakening line be somewhat wave-shaped like, for example, corrugated, triangular, rectangular or trapezoidal. The wave-shaped design of the primary weakening line is preferably symmetrical to a (phantom) line to the opposite lateral sides thereof the primary weakening line extends. This symmetry line can be a straight line or a curved line, that is, a line inclined with respect to the longitudinal dimension of the tube.

According to the above-mentioned preferred embodiment of the invention, the primary weakening line extends in a zig-zag-like manner within a strip-like area of the tube wherein this strip-like area has a defined width. The distance between a termination point of a secondary weakening line and the primary weakening line can be smaller than, equal to or larger than the width of the strip-like area.

It is also preferred to provide the unitary tube at the termination points of the secondary weakening lines with radially extending holes in order to facilitate bending of the strip when pulling out the same.

One can think about several designs for weakening the unitary tube along its primary and secondary weakening lines. Preferred methods are to provide perforations or a reduced thickness into the wall of the tube. Both the perforations and the reduced thickness can be provided in an extruded tube in which the primary and secondary weakening lines are formed by ablation of material of the tube using, for example, a laser, an electron beam or plasma to locally heat the tube so as to remove material from the tube. As an alternative, the tube can be cut mechanically using a knife or a similar cutting tool, or hydraulically using a fluid jet, such as a water jet with or without additional abrasive material in the fluid. In yet another alternative, the unitary tube can be injection molded wherein the mold is provided with the necessary structures for forming perforations or grooves or both in the wall of the tube.

From all of the methods mentioned above for forming the weakening lines in the tube, laser ablation is most preferred. It is known that certain polymers are decomposable by powerful laser energy. One example of such a polymer is poly-oximethylene (POM). Moreover, it is known that other polymers, although by themselves being not laser-ablatable, can be provided with this feature by incorporating suitable fillers like silica. By way of example only, polyolefins such as polyethylene and polypropylene, copolymers, polyamide, polyvinylcloride, starch modified biodegradable polymers can all be used as materials for the core. Suitable fillers for increasing IR absorption of the laser or other energy beam include carbon black, graphite and other suitable dyes. Many other materials which are laser-ablatable or ablatable by other kinds of energy beams are known and, accordingly, can be used in the invention.

The ablation process can be done from either the outside or the inside of the tube by deflecting the energy beam using devices like mirrors or the like or by direct application of the beam energy be means of an optical fiber. Depending on the desired characteristics of the core, the ablation can be non-penetrating, creating a continuous line of reduced thickness or can be locally penetrating so as to create a perforation-like structure or a combination of these measures. Another way to achieve the desired weakening lines is to combine a layer of non-ablatable polymer with a layer of ablatable polymer by, for example, co-extruding POM with a clear cellulose-acetate.

As indicated above, the removable core of the invention preferably can be formed from inexpensive extruded tubes as preforms to make the removable core for the PST with the advantage of creating a straight pull-out PST core. From a manufacturing standpoint, there is virtually no limit to the pattern of the weakening lines since in the prior art there are lasers and other cutting equipment which are CNC-controlled having a good repeatability and automation of the manufacturing process.

One additional advantage of the removable core of the invention is that due to the integrity of the unitary tube there are no portions of the tube extending out of the circumferential contour of the tube. This results in a design of the PST and core assembly which is acceptable to both the industry and the persons using the assembly.

According to another aspect of the invention there is provided a removable core, wherein each of the at least two weakening lines extends alternately to opposite lateral sides of a respective phantom line. In this embodiment, the core comprises at least two strips extending in a serpentine manner along around one half of the periphery of the unitary tube. Accordingly, when pulling at each of the strips the core can be removed from inside of the PST wherein the unwinding direction of each of the strips is inverted at each of the two primary weakening lines between which the strip extends.

In a further aspect of the invention, there is provided a removable core for supporting a pre-stretched elastomeric tube in a radially expanded condition comprising a unitary tube having first and second opposite ends, a plurality of sections of a primary line of localized weakening spaced apart and arranged adjacent to each other wherein the arrangement of the plurality of primary weakening line sections extends from the first end of the tube to the second end thereof and a plurality of substantially parallel secondary lines of localized weakening, a group of secondary weakening lines being associated to each of the primary weakening line sections, respectively, wherein each secondary weakening line of the group extends from the associated primary weakening line section at the one side thereof to a termination point at the other side of the respective primary weakening line section and spaced apart therefrom, wherein adjacent secondary weakening lines of the group extend from the respective primary weakening line section at different sides thereof to termination points at the respective other side of the respective primary weakening line section, and wherein from one end of a respective primary weakening line section there extends a secondary weakening line at the one side of this primary weakening line section to an opposite end of an adjacent primary weakening line section at the other side thereof to define a strip beginning at the first end of the tube and continuing substantially in a serpentine manner within the areas of the plurality of primary weakening line sections and continuing substantially helically between respective adjacent primary weakening line sections to the second end of the tube the strip comprising a free end starting from the second end of the tube and extending through the tube so as to project from the first end of the tube.

According to this embodiment, the unitary tube of the core of the invention has individual sections of a primary weakening line with the arrangement of these sections extending from the first end of the tube to its second end. The primary weakening line sections are arranged adjacent and spaced apart from each other wherein each section comprises two opposite ends and wherein two adjacent sections have their contracting ends spaced apart. The design of tube and the extension of the primary and secondary weakening lines within the area of each of the sections of the primary weakening line is as described above. In addition thereto, in this embodiment of the invention, there are secondary weakening lines starting at the one end of a primary weakening line section, continuing in a circumferential direction, and terminating at the confronting end of an adjacent primary weakening line section. By this arrangement of weakening lines the strip defined in the circumferential wall of the tube extends substantially in a serpentine manner within the areas of each of the primary weakening line sections while the strip extends substantially helically between adjacent primary weakening line sections.

When pulling at the strip, within the areas of each of the primary weakening line sections the unwinding direction of the strip is inverted by 180° after each winding and is inverted by 180° after at least two windings in the areas between two adjacent primary weakening line sections with the unwinding directions of the strip within the areas between each group of three successive primary weakening line sections are inverted with respect to each other. Accordingly, although the strip does not change its unwinding direction for more than one winding within the areas between successive primary weakening line sections, no twisting of the strip around the object to be covered by the PST occurs.

The primary weakening line sections can be straight or curved with the confronting ends of each pair of sections being displaced and in alignment circumferentially or in a substantial circumferential direction. The term curved in this connection means that the primary weakening line section not necessarily is bent smoothly but can also be in a zigzag shape, triangular or “u”- or “w”-shape. Between adjacent sections the secondary weakening line connecting the confronting edges of the two primary weakening line sections may extend for one or more windings so that the strip in this area extends substantially helically for several windings.

### BRIEF DESCRIPTION OF THE DRAWINGS

The present invention will be more thoroughly described with respect to the accompanying drawings in which like reference numerals refer to like parts in the several views and embodiments, and wherein:

FIG. 1 is a partially broken away side view of a PST supported by a removable core according to one embodiment of the invention wherein the removable core and the PST are positioned over a cable connector.

FIG. 2 is a perspective view of one embodiment of the removable core according to the present invention.

FIGS. 3-6 are side views of removable cores according to several embodiments of the invention differing with respect to the shape of the primary weakening line and the distances between the termination points and the secondary weakening lines to the primary weakening line.

FIG. 7 is a perspective view of another embodiment of the removable core according to the present invention.

FIGS. 8 and 9 are side views of additional embodiments of the removable core according to the present invention.

### DETAILED DESCRIPTION

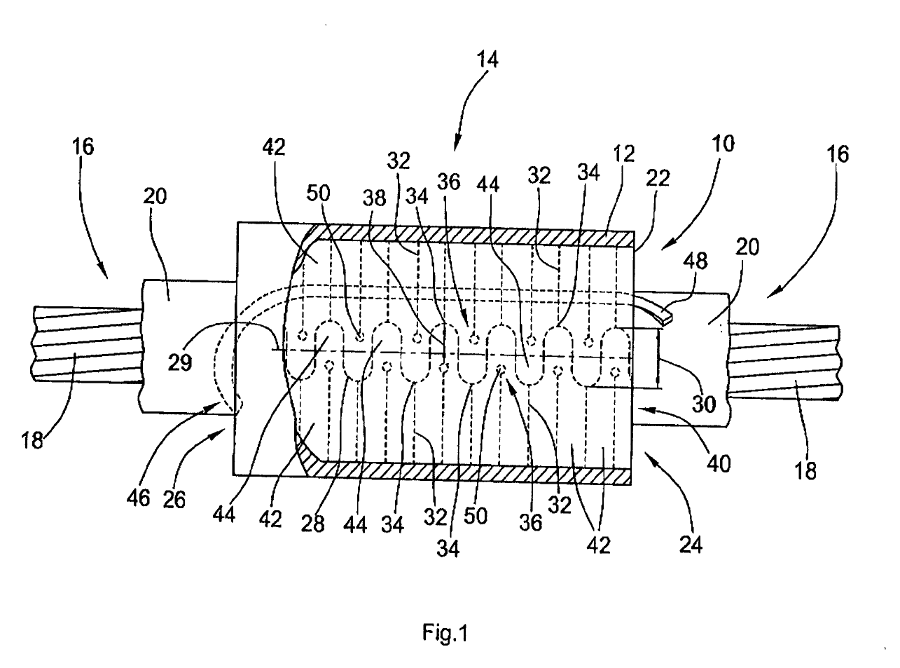

A first embodiment of a removable plastic core 10 supporting a cold shrinkable elastomeric tube 12 is shown in FIG. 1. The elastomeric tube 12 is partially cut away in order to illustrate the design of weakening lines formed in the hollow core 10. The covering assembly 14 comprising the removable core 10 and the pre-stretched and radially expanded elastic covering tube 12 is positioned over a cable connector (not shown for clarity of illustration) connecting two electrical cables 16 each comprising a conductor 18 and an insulating covering 20.

By removal of the hollow core 10 the radially expanded covering tube 12 contracts so as to sealingly contact the connector and the cables 16 circumferentially. If necessary, an insulating mastic or tape can be arranged between the insulating coverings 20 of the cables 16 and the elastic covering tube 12.

The cold shrinkable elastic covering tube 12 may be made from an elastic tube which may be expanded to a larger diameter and subsequently allowed to shrink back to substantially its original dimensions when the hollow supporting core 10 is removed.

In most applications, the precise chemical nature of the material used to form elastic covering tube 12 is not of particular importance except that it must possess sufficiently high elasticity which allows it to be stretched and then to shrink to substantially its original dimensions. Rubbery elastomers such as natural rubber, natural and synthetic polyisoprenes, cis-polybutadiene and styrene butadiene rubber, butadiene-acrylonitrile rubber, polychloroprene, (neoprene), butyl rubber, polysulphide rubber, silicone rubber, including liquid silicone rubber, urethane rubber, polyacrylate rubber, epichlorhydrin homo- and copolymer rubbers, propylene oxide rubber, fluorosilicone rubber, fluorocarbon rubber, chloro-sulphonated polyethylene rubber, chlorinated polyethylene rubber, ethylene-propylene rubber, ethylene-propylene-diene monomer terpolymer rubber (EPDM), nitroso rubber, phosphonitrilic rubber, or polyurethanes, including two component polyurethanes, polyurethane elastomers and polyurethane thermoplastic elastomers (TPE) may be suitable. Preferred materials include ethylene-propylene-diene monomer terpolymers (EPDM) and silicone rubbers. Any of the above materials may be formulated in a variety of compositions by including flame retardants, conductive materials, materials to improve weathering properties, materials to produce electrical stress grading properties, glass or carbon fibers, inert fillers and so forth. In particular, the elastic covering tube 12 may be insulating, conductive or electrically stress grading as required for telecommunication, medium or high voltage applications.

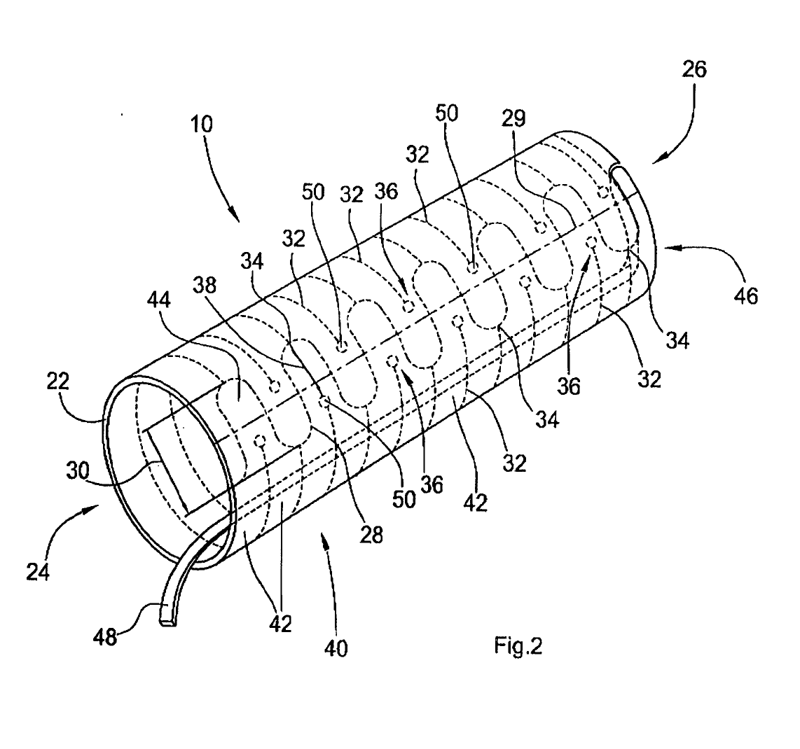

The hollow plastic supporting core 10 is shown in FIG. 1 in a side view and in FIG. 2 in an isometric view. Accordingly, the core 10 is comprised of a tube 22 having a first end 24 and an opposite second end 26 defining the longitudinal dimension of the core 10. Moreover, in the wall of the tube 22 there is formed a primary weakening line 28 extending from the first end 24 of the tube 22 to its second end 26. The primary weakening line 28 is corrugated, extends over a width 30 in circumferential direction of the tube 22, and is symmetrical to a phantom line 29.

Transversely to the primary weakening line 28 there extends a plurality of parallel secondary weakening lines 32 in circumferential direction of the tube 22. Each secondary weakening line 32 at 34 starts from the primary weakening line 28 and extends at the one side thereof circumferentially to a termination point 36 located at the opposite other side of the weakening line. The termination points 36 are spaced from the locations 34 on the primary weakening line 28 where the secondary weakening lines 32 start, by a distance 38 in the circumferential direction. In this embodiment the distance 38 is smaller than the width 30.

When viewing at the core 10 from its lateral side, the primary weakening line 28 can be regarded as a wave form function. The locations 34 at which the secondary weakening lines 32 start are alternately located at the hills and valleys of the corrugated primary weakening line 28 wherein the termination points 36 are located between two adjacent hills or two adjacent valleys, respectively. By this design, the wall of the tube 22 can be regarded as being built by a strip or ribbon 40 extending in a serpentine manner circumferentially of the tube 22 wherein adjacent portions 42 of the strip 40 are separated by a secondary weakening line 32. Each portion 42 of the strip 40 extends around 360° of the tube 22 wherein adjacent portions 42 are connected by connecting portions 44 limited by a portion of the primary weakening line 28 and extending around a termination point 36. At the second end 26 of the tube 22, the strip 40 continues so as to form a free end 46 extending from the second end 26 of the tube 22 through the tube 22 so as to project from the first end 24 of the tube 22 forming a portion 48 which can be grasped manually or by means of a suitable tool (tongs or the like).

Along the primary 28 and secondary 32 weakening lines the wall of the tube 22 is weakened. These weakening lines are built by means of perforations extending through the wall of the tube 22 with web portions of the tube wall between adjacent portions or by means of grooves formed in the outer side or inner side of the tube 22. The perforations or grooves most preferably are built by ablating material out of the wall of the tube 22. This can be performed by means of a laser beam using a laser ablatable plastic material like POM for the tube 22. The termination points 36 are preferably provided as radially extending holes 50 also formed in the tube by laser ablation.

Referring back to FIG. 1, for removing the core 10 out of the pre-stretched covering tube 12 one has to pull at the grasping portion 48 away from the first end 24 of the core 10 resulting in an unwinding of portions 42 of the strip 40 which unwinding starts at the second end 26 of the core 10 towards its first end 24. When unwinding, the strip 40 does not wind for more than 360° around the cables 16 since after 360° unwinding in the one direction the moving direction of the strip 40 is inverted for 360° and so on. Therefore, the strip 40 can be pulled straight out.

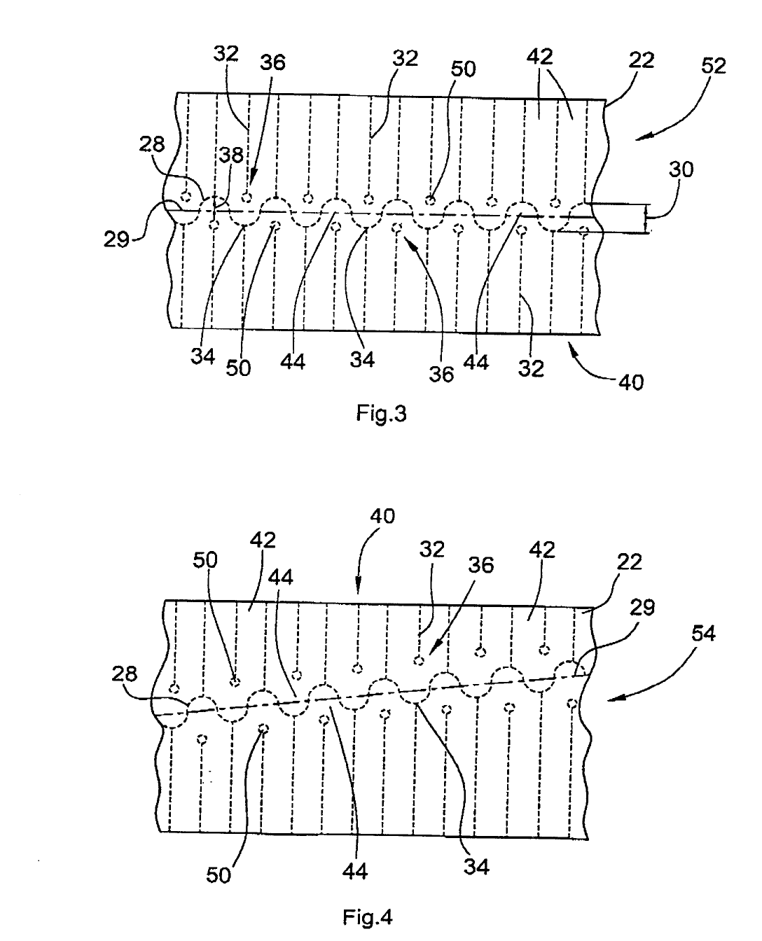

FIGS. 3 to 6 show individual embodiments of different supporting cores 52, 54, 56 and 58 according to individual embodiments of the invention. In these Figures like reference numerals are used for those parts which are similar or identical to the individual parts of the core 10 according to FIGS. 1 and 2.

As in FIGS. 1 and 3, the primary weakening line 28 of the core 52 of FIG. 3 is corrugated. However, the distance 38, by which the termination points 36 of the secondary weakening lines 32 are spaced apart from the locations 34 where the secondary weakening lines 32 start, is substantially identical to the width 30.

According to FIG. 4, the overall extension of the primary weakening line 28 is inclined with respect to the longitudinal dimension of the core 54. Accordingly, the primary weakening line 28 although itself corrugated extends helically with respect to the longitudinal dimension of the core 54.

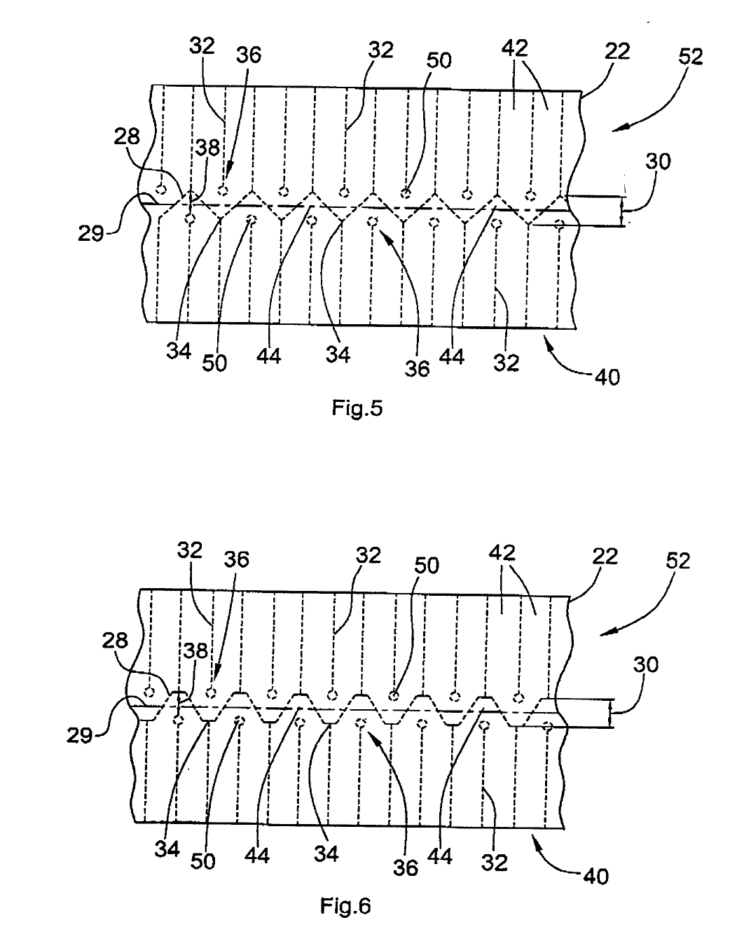

FIGS. 5 and 6 each shows cores 56 and 58 respectively having a triangular or trapezoidal primary weakening line 28.

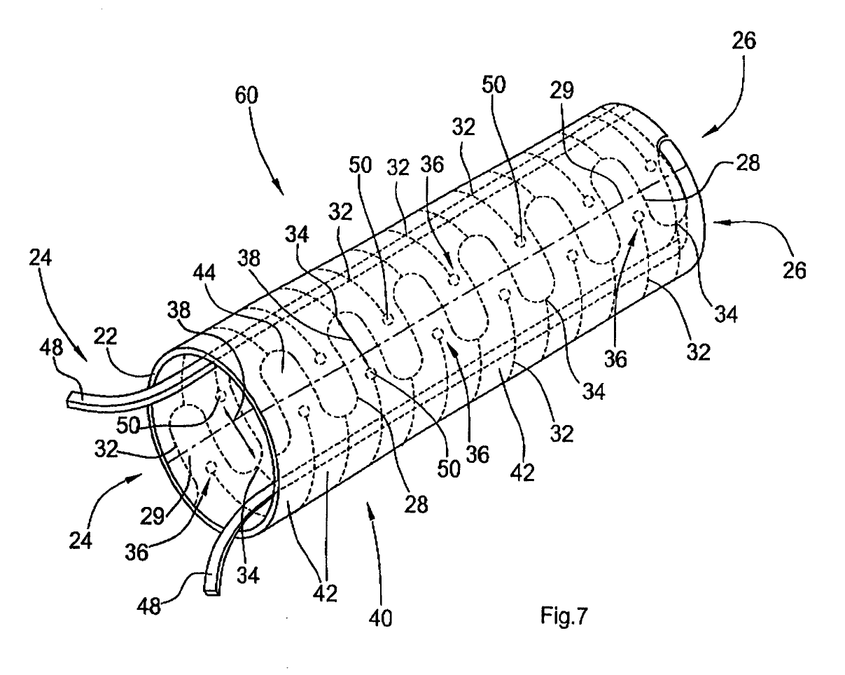

Finally, in FIG. 7 a perspective view of another embodiment of a core 60 according to the invention is shown. Also in this Figure those parts of the core 60 which are similar to corresponding parts of the cores according to the other embodiments, are specified by like reference numerals.

The specific feature of the core 60 of FIG. 7 is that its tube 22 is comprised of two strips 40 each extending over 180° in a serpentine manner and terminating at separated grasping ends 48. For this purpose the tube 22 of the core 60 is provided with two primary weakening lines 28 displaced relative to each other by 180°. Both primary weakening lines 28 are corrugated wherein between these two primary weakening lines 28 there extend the secondary weakening lines 32 circumferentially from a point 34 at the one primary weakening line 28 to a termination point 36 spaced apart in circumferential direction by a distance 38 from the other one of the primary weakening lines 28. Accordingly, each of the two strips 40 is comprised of adjacent circumferentially extending portions 42 and portions 44 connecting adjacent portions 42 of the strip 40 wherein each portion 42 extends over around 180° in circumferential direction of the tube 22 so that each of the strips 40 continues in a serpentine manner over 180° along the longitudinal direction of the tube 22. By pulling at the grasping ends 48 of both of the strips 40 the core 60 is removable out of a pre-stretched elastomeric tube (not shown in FIG. 7) supported by the core 60.

As an alternative, the two strips 40 at the second end 26 of the tube 22 of the core 10 can be connected so that only one free end extends through the tube 22 and projects over the first end 24 of the tube so that by pulling at one end both strips 40 are unwound from the core 60. Furthermore it is possible that the two free ends 46 of the strips are connected along their lengths so that pulling at these connected ends results in unwinding of both strips 40.

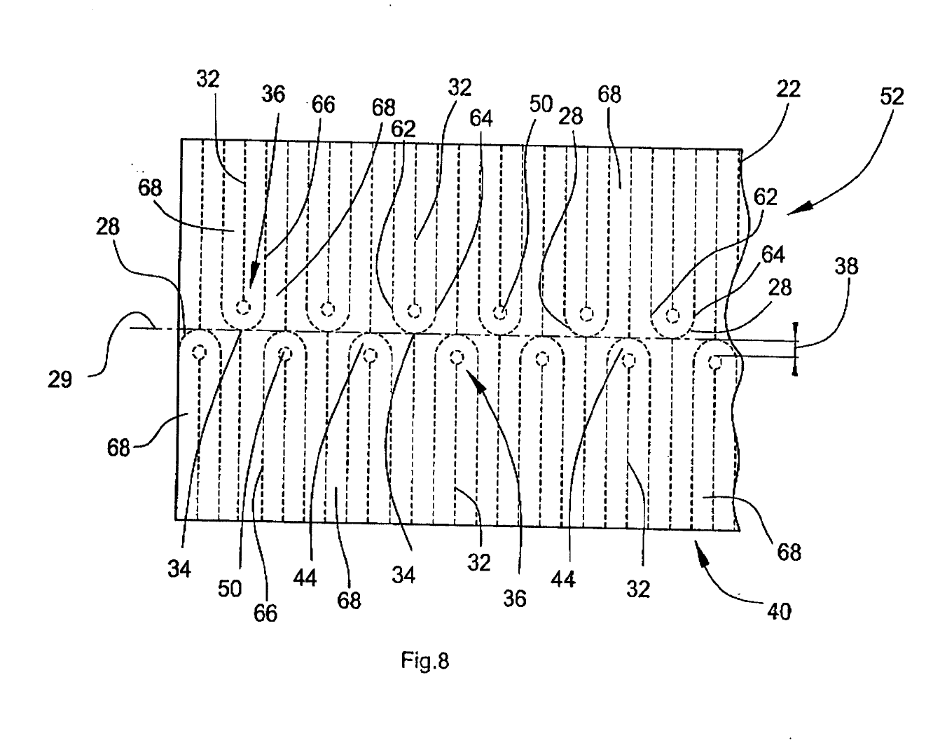

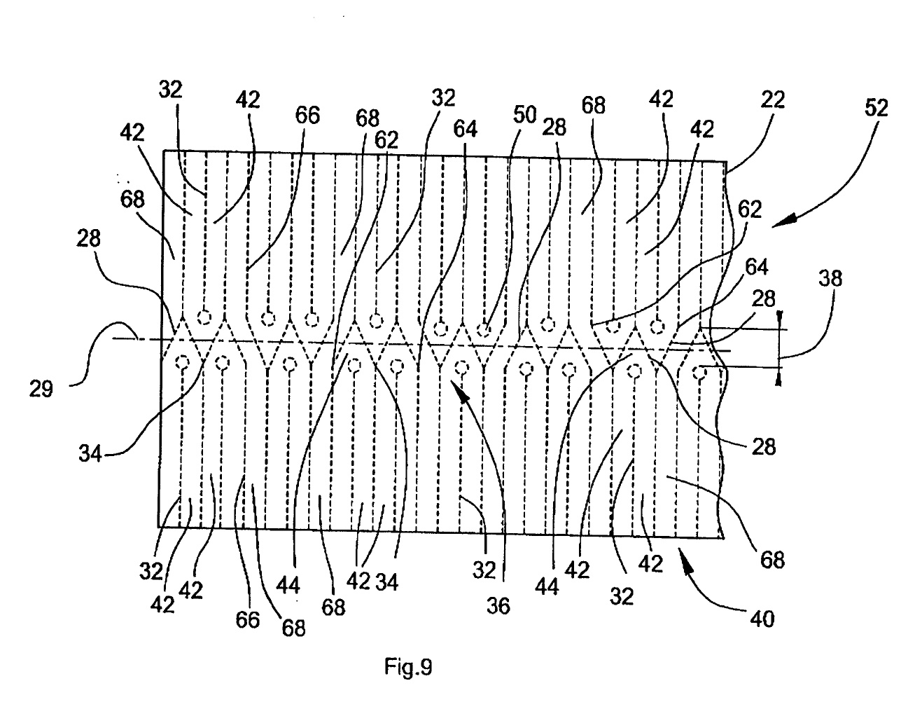

In FIGS. 8 and 9 two additional embodiments of a removable core for a PST are shown with like reference numerals indicating like parts as in the other Figures. All the features and characteristics of the core according to the other embodiments described so far apply correspondingly to the embodiments of FIGS. 8 and 9.

In contrast to the other embodiments, in FIGS. 8 and 9, the primary weakening line is separated into successively arranged adjacent sections 28 having opposite ends 62, 64 wherein the confronting ends 62, 64 of adjacent sections 28 are displaced in circumferential direction. Adjacent sections 28 are oriented opposite to each other and are curved or zig-zag-shaped. Within the areas of the sections 28 the extension and arrangement of the secondary weakening lines 32 are identical to the other embodiments of FIGS. 1 to 7. However, the confronting ends 62, 64 of adjacent sections 28 of the primary weakening line are connected by a secondary weakening line 66. Accordingly, the strip 40 exclusively comprises sections 68 each extending for two windings. In FIG. 9 there are two sections 42 for each primary weakening line section 42 of the strip. Moreover, in FIG. 8 the primary weakening line sections 28 are curved smoothly, extend along a half circle, and arranged alternately at opposite sides of the phantom line 29 so as to be displaced in circumferential direction while in FIG. 9 the primary weakening line sections 28 are zig-zag shaped like the character “w” and interleaved so that each section 28 extends both sides of the phantom line 29.

As will be apparent to those skilled in the art, in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A removable core for supporting a pre-stretched elastomeric tube in a radially expanded condition comprising:
a tube having a first end and a second end,
at least one primary line of localized weakening starting at the first end and terminating at the second end of the tube, and
a plurality of substantially parallel secondary lines of localized weakening, wherein each secondary weakening line extends from the at least one primary weakening line at the one side thereof to a termination point at the other side of the at least one primary weakening line and spaced apart therefrom and wherein adjacent secondary weakening lines alternately extend from the at least one primary weakening line to termination points on opposite sides of the at least one primary weakening line to define at least one strip beginning at the first end of the tube and continuing substantially in a serpentine manner to the second end of the tube.

2. The removable core according to claim 1, wherein the at least one strip comprises a free end starting from the second end of the tube and extending through the tube so as to project from the first end of the tube.

3. The removable core according to claim 1, wherein each secondary weakening line extends substantially circumferentially about the tube.

4. The removable core according to claim 1, wherein the at least one primary weakening line extends alternately to opposite lateral sides of a straight phantom line.

5. The removable core according to claim 4, wherein the at least one primary weakening line extends symmetrically to the phantom line.

6. The removable core according to claim 1, wherein the at least one primary weakening line has a periodical corrugated, zig-zag-shaped, triangular, rectangular, or trapezoidal wave form.

7. The removable core according to claim 1, wherein for all of the secondary weakening lines the distance in circumferential direction by which a termination point of a secondary weakening line is spaced from the at least one primary weakening line is constant.

8. The removable core according to claim 3, wherein for all of the secondary weakening lines the distance in circumferential direction by which a termination point of a secondary weakening line is spaced from the at least one primary weakening line is smaller than a width defined by two successive outermost locations of the at least one primary weakening line arranged on opposite lateral sides of the phantom line.

9. The removable core according to claim 8, wherein the distance is substantially the width of the strip within its portions close to the termination points.

10. The removable core according to claim 1, wherein the tube at the termination points of the secondary weakening lines is provided with radially extending holes.

11. The removable core according to claim 1, wherein the overall extension of the at least one primary weakening line is inclined with respect to a longitudinal dimension of the tube.

12. The removable core according to claim 1, wherein the primary and secondary weakening lines are comprised of perforations in the tube.

13. The removable core according to claim 1, wherein the tube along its primary and secondary weakening lines has a reduced thickness in relation to the remaining parts of the tube.

14. The removable core according to claim 1, wherein the primary and secondary weakening lines are formed by ablation of material of the tube by means of a laser or electron beam, plasma or fluid jet application or by means of mechanically cutting of the tube.

15. A removable core for supporting a pre-stretched elastomeric tube in a radially expanded condition comprising
a tube having first and second opposite ends,
at least two primary lines of localized weakening starting at the first end and terminating at the second end of the tube, and spaced apart in circumferential dimension of the tube, and
a plurality of substantially parallel secondary lines of localized weakening, wherein each secondary weakening line extends substantially circumferentially of the tube between two adjacent primary weakening lines from one primary weakening line to a termination point spaced apart from the other primary weakening line and wherein adjacent secondary weakening lines between two respective adjacent primary weakening lines alternately extend from different primary weakening lines to termination points spaced apart from the respective other primary weakening line to define at least two strips each beginning at the first end of the tube and substantially circumferentially continuing in a serpentine manner to the second end of the tube.

16. The removable core according to claim 15, wherein the at least two strips each comprise a free end starting from the second end of the tube and extending through the tube so as to project from the first end of the tube.

17. The removable core according to claim 15, wherein each secondary weakening line extends substantially circumferentially of the tube.

18. The removable core according to claim 15, wherein each of the at least two weakening lines extends alternately to opposite lateral sides of a straight phantom line.

19. The removable core according to claim 18, wherein each of the at least two weakening lines extends symmetrically to the respective phantom line.

20. The removable core according to claim 17, wherein each of the at least two weakening lines has a periodical corrugated, zig-zag-shaped, triangular, rectangular, or trapezoidal wave form.

21. The removable core according to claim 17, wherein for all of the secondary weakening lines the distance in circumferential direction by which a termination point of a secondary weakening line is spaced from the respective one of the at least two weakening lines is constant.

22. The removable core according to claim 18, wherein for all of the secondary weakening lines the distance in circumferential direction by which a termination point of a secondary weakening line is spaced from the respective one of the at least two weakening lines is smaller than a width defined by two successive outermost locations of the respective one of the at least two weakening lines arranged on opposite lateral sides of the respective phantom line.

23. The removable core according to claim 22, wherein the distance is substantially the width of the strip within its portions close to the termination points.

24. The removable core according to claim 17, wherein the tube at the termination points of the secondary weakening lines is provided with radially extending holes.

25. The removable core according to claim 17, wherein the overall extension of each of the at least two weakening lines is inclined with respect to a longitudinal dimension of the tube.

26. The removable core according to claim 17, wherein the primary and secondary weakening lines are comprised of perforations in the tube.

27. The removable core according to claim 17, wherein the tube along its primary and secondary weakening lines has a reduced thickness in relation to the remaining parts of the tube.

28. The removable core according to claim 17, wherein the primary and secondary weakening lines are formed by ablation of material of the tube by means of a laser or electron beam, plasma or fluid jet application or by means of mechanically cutting of the tube.

29. A removable core for supporting a pre-stretched elastomeric tube in a radially expanded condition comprising
a unitary tube having first and second opposite ends,
a plurality of sections of a primary line of localized weakening spaced apart and arranged adjacent to each other wherein the arrangement of the plurality of primary weakening line sections extends from the first end of the tube to the second end thereof and
a plurality of substantially parallel secondary lines of localized weakening, a group of the secondary weakening lines being associated to each of the primary weakening line sections, respectively, wherein each secondary weakening line of the group extends from the associated primary weakening line section at the one side thereof to a termination point at the other side of the respective primary weakening line section and spaced apart therefrom, wherein adjacent secondary weakening lines of the group extend from the respective primary weakening line section at different sides thereof to termination points at the respective other side of the respective primary weakening line section, and wherein from one end of a respective primary weakening line section there extends a secondary weakening line at the one side of this primary weakening line section to an opposite end of an adjacent primary weakening line section at the other side thereof to define a strip beginning at the first end of the tube and continuing substantially in a serpentine manner within the areas of the plurality of primary weakening line sections and continuing substantially helically between respective adjacent primary weakening line sections to the second end of the tube the strip comprising a free end starting from the second end of the tube and extending through the tube so as to project from the first end of the tube.

30. The removable core according to claim 29, wherein opposite ends of two respective adjacent primary weakening line sections are located at opposite lateral sides of a phantom line.

31. The removable core according to claim 29, wherein two respective adjacent primary weakening line sections are curved in opposite directions.

32. The removable core according to claim 30, wherein the opposite ends of two respective adjacent primary weakening line sections are displaced in a substantially circumferential direction and are in alignment with respect to each other.

33. The removable core according to claim 29, wherein the secondary weakening lines extending from one primary weakening line section to an adjacent one comprises at least one winding around the tube.

34. The removable core according to claim 29, wherein each secondary weakening line extends substantially circumferentially of the tube.

35. The removable core according to claim 29, wherein the arrangement of the plurality of primary weakening line sections extends alternately to opposite lateral sides of a phantom line.

36. The removable core according to claim 35, wherein the phantom line is a straight line and is substantially parallel to the longitudinal axis of the core.

37. The removable core according to claim 35, wherein the arrangement of the plurality of primary weakening line sections extends symmetrically to the phantom line.

38. The removable core according to claim 29, wherein the arrangement of the plurality of primary weakening line sections has a periodical corrugated, zig-zag-shaped, triangular, rectangular, or trapezoidal wave form.

39. The removable core according to claim 29, wherein for all of the secondary weakening lines the distance in circumferential direction by which a termination point of a secondary weakening line is spaced from the at least one primary weakening line is constant.

40. The removable core according to claim 29, wherein for all of the secondary weakening lines the distance in circumferential direction by which a termination point of a secondary weakening line is spaced from a primary weakening line sections is smaller than a width defined by two successive outermost locations of the arrangement of the plurality of primary weakening line sections arranged on opposite lateral sides of the phantom line.

41. The removable core according to claim 40, wherein the distance is substantially the width of the strip within its portions close to the termination points.

42. The removable core according to claim 29, wherein the tube at the termination points of the secondary weakening lines is provided with radially extending holes.

43. The removable core according to claim 29, wherein the overall extension of the arrangement of the plurality of primary weakening line sections is inclined with respect to a longitudinal dimension of the tube.

44. The removable core according to claim 29, wherein the primary and secondary weakening lines are comprised of perforations in the tube.

45. The removable core according to claim 29, wherein the tube along its primary and secondary weakening lines has a reduced thickness in relation to the remaining parts of the tube.

46. The removable core according to claim 29, wherein the secondary weakening lines extending from one primary weakening line section to an adjacent one comprises at least one winding along the tube.
